(19) United States
(12) Patent Application Publication
(10) Pub. No.: US 2025/0376562 A1
(43) Pub. Date: Dec. 11, 2025

(54) Poly(oxazoline)- and poly(oxazine)-based lipids, process for the preparation thereof, and use thereof

(71) Applicant: NGP Polymers GmbH, Jena (DE)

(72) Inventors: Caroline Holick, Jena (DE); Tobias Klein, Jena (DE); Ulrich S. Schubert, Jena (DE)

(21) Appl. No.: 18/876,427

(22) PCT Filed: Jun. 15, 2023
(86) PCT No.: PCT/EP2023/000036

§ 371 Date: Dec. 18, 2024

(30) Foreign Application Priority Data
Jun. 21, 2022 (DE) 10 2022 002 240.0

(51) Int. Cl. C08G 73/02

(52) U.S. Cl. CPC C08G 73/0233

(57) ABSTRACT

Poly(oxazoline)- and poly(oxazine)-based lipids, process for the preparation thereof, and use thereof

Disclosed are polymers of formulae (I) or (II)

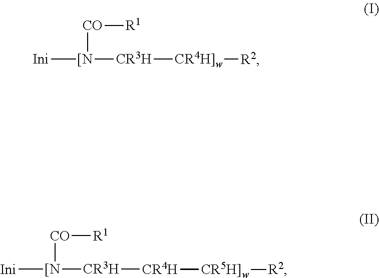

or polymers containing, based on all structural units, 10 to 95 mol % of structural units of the formula (III), 5 to 90 mol % of structural units of the formula (IV) and 0 to 20 mol % of structural units of the formula (V)

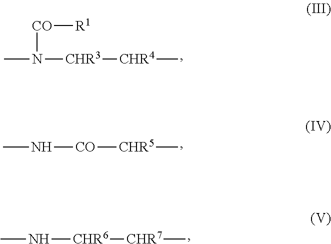

or containing 10 to 95 mol % of structural units of the formula (VI), 5 to 90 mol % of structural units of the formula (VII) and 0 to 20 mol % of structural units of the formula (VIII)

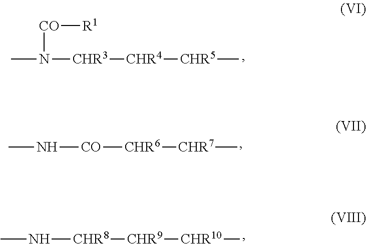

wherein at least one of the structural units of formula (III), (IV) or (V) or of formula (VI), (VII) or (VIII) with the grouping —CHR⁴—, —CHR⁵— or CHR⁷— or with the grouping —CHR⁵—, —CHR⁷— or —CHR¹⁰— is covalently bonded to a radical R², wherein
Ini is a radical derived from an initiator of the cationic polymerization,
R¹ is selected from the group consisting of hydrogen or C₁-C₄ alkyl,
R² is selected from the group consisting of —OR¹¹, —OCO—R¹¹, —OCO—R¹⁴—CO—OR¹¹, —OCO—R¹⁴—CO—NR¹²R¹³, —NR¹²—R¹⁴—CO—NR¹³R¹⁵, —O—R¹⁶—(O—OC—R¹⁸)ₘ and

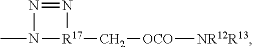

R³, R⁴, R⁵, R⁶, R⁷, R⁸, R⁹ and R¹⁰ independentlky of one another are hydrogen, methyl, ethyl, propyl or butyl,
R¹¹ is C₆-C₂₀ alkyl,
R¹² and R¹⁵ independently of one another are hydrogen or alkyl,
R¹³ is C₆-C₂₀ alkyl,
R¹⁴ is alkylene, cycloalkylene, arylene or aralkylene,
R¹⁶ is an m+1-valent aliphatic hydrocarbon radical,
m is an integer from 1 to 5,
R¹⁸ is C₆-C₂₀ alkyl, with the proviso, that several residues R¹⁸ of a residue R¹⁶ may be different within the scope of the given definitions,
R¹⁷ is a trivalent bicyclic residue, and
w is an integer in the range from 1 to 5000.

These polymers are amphiphilic and can be used as a replacement for polyethylene glykols, for example in formulations comprising active ingredients.

### DISCLOSURE

Poly(oxazoline)- and poly(oxazine)-based lipids, process for the preparation thereof, and use thereof

### CLAIM FOR PRIORITY

This application is a national phase application of German Patent Application 10 2022 002 240.0, filed Jun. 21, 2022, and PCT/EP2023/000036 filed Jun. 15, 2023 the priority of which are hereby claimed and their disclosure incorporated by reference herein in its entirety.

### FIELD OF THE INVENTION

The invention relates to new polymeric lipids which are suitable as substitutes for polyethylene glycols (hereinafter also referred to as “PEG”). Furthermore, the invention relates to the preparation of these polymers and their use in the preparation of pharmaceutical formulations.

### BACKGROUND OF THE INVENTION

Biocompatible polymers are highly attractive materials for biomedical applications such as drug delivery. PEGs are widely used in pharmaceutical products due to the benefits associated with their use. For example, in the SARS-COV-2 mRNA vaccines, lipid nanoparticles containing PEG lipids as a key component are used to transport the mRNA. In these lipid nanoparticles, the PEG lipids not only influence the particle size during production, but also prevent the aggregation of the particles and contribute to their storage stability. In addition, PEG prolongs the circulation time of the particles in the blood due to its stealth effect, thus preventing rapid recognition by the immune system and elimination (cf. X. Hou, T. Zaks, R. Langer, Y. Dong, Nat. Rev. Mater. 2021, 6, 1078-1094).

However, so-called PEGylation also has considerable disadvantages, which are referred to as the “PEG dilemma”. The stimulation of anti-PEG antibodies, which prevail in humans due to excessive use of PEG also in cosmetics, results in accelerated clearance in the blood, so that PEGylated particles cannot reach their desired site of action efficiently, leading to a reduced effect. In addition to lower transfection efficiency, e.g. in SARS COV 2 mRNA vaccines, anti-PEG antibodies can also lead to hypersensitivity reactions that manifest as pseudoallergy in humans (see T. Ishida, M. Ichihara, X. Wang, K. Yamamoto, J. Kimura, E. Majima, H. Kiwada, J. Controlled Release 2006, 112, 15-25 and S. S. Nogueira, A. Schlegel, K. Maxeiner, B. Weber, M. Barz, M. A. Schroer, C. E. Blanchet, D. I. Svergun, S. Ramishetti, D. Peer, P. Langguth, U. Sahin, H. Haas, ACS Appl. Nano Mater. 2020, 3, 10634-10645).

In addition to these disadvantages, a further problem with the use of PEG is the formation of toxic by-products such as 1,4-dioxane during synthesis and of PEG oligomers through sequential oxidation when using PEG with lower molar masses (cf. K. Knop, R. Hoogenboom, D. Fischer, U. S. Schubert, Angew. Chem. Int. Ed. 2010, 49, 6288-6308). It is therefore important to create PEG alternatives.

Poly(2-n-alkyl-2-oxazolines) (hereinafter also referred to as “PAOx”) with short side chains show similar hydrophilicity, biocompatibility and “stealth effect” and therefore seem to be promising candidates for a replacement of PEG, which was furthermore confirmed in a detailed comparison of their dissolution behavior (cf. M. Grube, M. N. Leiske, U. S. Schubert, I. Nischang, Macromolecules 2018, 51, 1905-1916). In contrast to PEG, PAOx also exhibit greater structural versatility due to their side-chain modifiability.

PAOx with longer side chains are hydrophobic and can be used to produce amphiphilic copolymers, low surface energy materials or low adhesion coatings. Thermal and crystalline properties can also be adjusted by variations in the PAOx side chains (see R. Hoogenboom, M. W. M. Fijten, H. M. L. Thijs, B. M. van Lankvelt, U. S. Schubert, Designed Monomers and Polymers 2005, 8, 659-671; E. F. J. Rettler, J. M. Kranenburg, H. M. L. Lambermont-Thijs, R. Hoogenboom, U. S. Schubert, Macromolecular Chemistry and Physics 2010, 211, 2443-2448; K. Kempe, M. Lobert, R. Hoogenboom, U. S. Schubert, Journal of Polymer Science Part A: Polymer Chemistry 2009, 47, 3829-3838; M. Beck, P. Birnbrich, U. Eicken, H. Fischer, W. E. Fristad, B. Hase, H. J. Krause, Die Angewandte Makromolekulare Chemie 1994, 223, 217-233; J. M. Rodriguez-Parada, M. Kaku, D. Y. Sogah, Macromolecules 1994, 27, 1571-1577; N. Oleszko-Torbus, A. Utrata-Wesołek, M. Bochenek, D. Lipowska-Kur, A. Dworak, W. Wałach, Polymer Chemistry 2020, 11, 15-33; A. L. Demirel, P. Tatar Güner, B. Verbraeken, H. Schlaad, U. S. Schubert, R. Hoogenboom, Journal of Polymer Science Part B: Polymer Physics 2016, 54, 721-729). Schubert and colleagues previously reported a decrease in glass transition temperature (T_{g}) with increasing side chain length for a range of poly(2-n-alkyl-2-oxazolines) to poly(2-pentyl-2-oxazolines). For PAOx with longer side chains, crystalline properties with a melting temperature Tₘ independent of the side chain length were observed.

Polyoxazolines PAOx, whereby poly(2-ethyl-2-oxazolines) are of particular interest, therefore appear to be an alternative to PEG, as they also have a stealth effect like PEG. It is assumed that PAOx lipids can be an alternative for PEG lipids, for example for the PEG lipid ALC 0159, which is used in the BioNTech mRNA vaccine “Comirnaty®”.

There is already work in which PEG lipid alternatives have been synthesized. S. NOGUEIRA et al. produced lipids from polysarcosine (pSar) in collaboration with BioNTech. However, these pSar lipids showed lower transfection compared to a PEG-lipid reference, making them an unattractive alternative for vaccination (see S. S. Nogueira, A. Schlegel, K. Maxeiner, B. Weber, M. Barz, M. A. Schroer, C. E. Blanchet, D. I. Svergun, S. Ramishetti, D. Peer, P. Langguth, U. Sahin, H. Haas, ACS Appl. Nano Mater. 2020, 3, 10634-10645).

M. BENTLEY et al. synthesized lipids from polyoxazolines in which phospholipids were coupled to the PAOx (cf. U.S. Pat. No. 9,284,411 B2 and U.S. Pat. No. 8,883,211 B2).

PAOx and PEG are not biodegradable, but for many biomedical applications it is important to prevent a long accumulation of polymers with higher molecular masses.

It would therefore be desirable to have lipids based on biodegradable polyoxazolines (hereinafter also referred to as “degPAOx”) available to ensure biodegradability. The synthesis of degPAOx has already been reported (cf. N. E. Göppert, M. Kleinsteuber, C. Weber, U. S. Schubert, Macromolecules 2020, 53, 10837-10846) and WO 2022/106049 A1.

Functionalized polyglycine-poly(alkyleneimine) copolymers are known from WO 2022/106049 A1. Polymers with long-chain alkyl groups or with long-chain alkyl ester groups as end groups are not disclosed in this document.

The use of PAOx lipids and degPAOx lipids is not limited to vaccine applications, but these lipids can generally be used as carrier materials for the delivery of drugs or genes.

Using analytical ultracentrifugation, the hydrodynamic radii of the PEG-lipid alternatives can be measured. In this way, the molar mass of the PAOx lipids and degPOx lipids can be precisely matched to the hydrodynamic volume of commercial PEG types, e.g. the commercial PEG lipid ALC-0159, facilitating a potential replacement of the PEG lipids by the PAOx lipids and degPAOx lipids in existing biomedical applications.

### SUMMARY OF THE INVENTION

The objective of the present invention is therefore to provide new polymeric lipids which are suitable as substitutes for PEG lipids.

A further objective of the present invention is to provide simple methods for producing these polymeric lipids.

This objective is solved by providing a first group of polymers of the formulae (I) or (II).

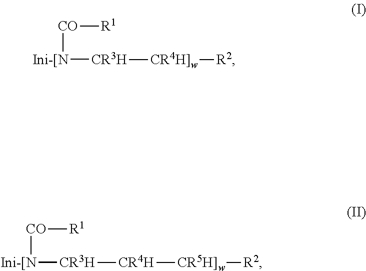

or by providing a second group of polymers containing, based on all structural units, 10 to 95 mol % of structural units of the formula (III), 5 to 90 mol % of structural units of the formula (IV) and 0 to 20 mol % of structural units of the formula (V)

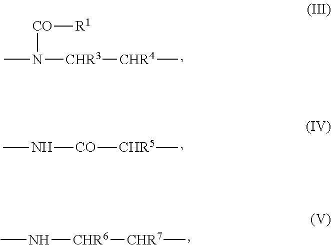

or containing 10 to 95 mol % of structural units of the formula (VI), 5 to 90 mol % of structural units of the formula (VII) and 0 to 20 mol % of structural units of the formula (VIII)

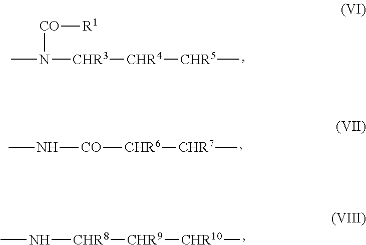

wherein at least one of the structural units of formula (III), (IV) or (V) or of formula (VI), (VII) or (VIII) with the grouping —CHR⁴—, —CHR⁵— or CHR⁷— or with the grouping —CHR⁵—, —CHR⁷— or —CHR¹⁰— is covalently bonded to a radical R², wherein
Ini is a radical derived from an initiator of the cationic polymerization,
R¹ is selected from the group consisting of hydrogen or C₁-C₄ alkyl,
R² is selected from the group consisting of —OR¹¹, —OCO—R¹¹, —OCO—R¹⁴—CO—OR¹¹, —OCO—R¹⁴—CO—NR¹²R¹³, —NR¹²—R¹⁴—CO—NR¹³R¹⁵, —O—R¹⁶—(O—OC—R¹⁸)ₘ and

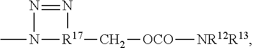

R³, R⁴, R⁵, R⁶, R⁷, R⁸, R⁹ and R¹⁰ independentlky of one another are hydrogen, methyl, ethyl, propyl or butyl,
R¹¹ is C₆-C₂₀ alkyl,
R¹² and R¹⁵ independently of one another are hydrogen or alkyl,
R¹³ is C₆-C₂₀ alkyl,
R¹⁴ is alkylene, cycloalkylene, arylene or aralkylene,
R¹⁶ is an m+1-valent aliphatic hydrocarbon radical,
m is an integer from 1 to 5,
R¹⁸ is C₆-C₂₀ alkyl, with the proviso, that several residues R¹⁸ of a residue R¹⁶ may be different within the scope of the given definitions,
R¹⁷ is a trivalent bicyclic residue, and
w is an integer in the range from 1 to 5000.

### BRIEF DESCRIPTION OF THE DRAWINGS

FIG. 1 shows a schematic representation of the synthesis of PEtOx lipids.

FIG. 2 shows a schematic representation of the synthesis of a degPOx lipid.

### DETAILS OF THE INVENTION

In the context of the present description, “polymers” are to be understood as the above-mentioned organic compounds characterized by the repetition of certain units (monomer units or repeating units). Polymers can consist of one type or several types of different repeating units. Polymers are produced by the chemical reaction of monomers with the formation of covalent bonds (polymerization) and form the so-called polymer backbone by linking the polymerized units. This can have side chains on which functional groups can be located. If polymers partly have hydrophobic properties, they can form nanoscale structures (e.g. nanoparticles, micelles, vesicles) in an aqueous environment. Homopolymers consist of only one monomer unit. Copolymers, on the other hand, consist of at least two different monomer units, which can be arranged randomly, as a gradient, alternating or as a block.

The polymers according to the invention are functionalized poly(oxazolines) or poly(oxazines). The former are derived from oxazolines and the latter from oxazines. The following description focuses mainly on the production and use of poly(oxazolines). These explanations also apply analogously to the homologous poly(oxazines).

In the context of the present description, “lipids” are understood to mean substances which are completely or at least largely insoluble in water (hydrophobic) and which dissolve well in hydrophobic (Iipophilic) solvents. Lipids are amphiphilic and represent a subgroup of surfactants. In polar solvents such as water, lipids often form micelles, vesicles or membranes.

In the context of the present description, “active ingredients” means compounds or mixtures of compounds that exert a desired effect on a living organism. These may be, for example, active pharmaceutical ingredients or active agrochemical ingredients. Active ingredients can be low or high molecular weight organic compounds. Preferably, the active ingredients are low molecular weight pharmaceutically active substances or higher molecular weight pharmaceutically active substances, whereby in particular hydrophilic active ingredients from potentially therapeutically useful nucleic acids (e.g. short interferin RNA, short hairpin RNA, micro RNA, messenger RNA, plasmid DNA) or from potentially useful proteins (e.g. antibodies, interferons, cytokines) can be used. Preferred examples of active ingredients are vaccines or nucleic acids.

Active ingredients can be those which, without inclusion in a nanoparticle or a liposome, only have low or no bioavailability, have low or no stability in vivo or are only intended to act in certain cells of an organism.

In the context of the present description, “excipients and additives” are understood to mean substances that are added to a formulation in order to give it certain additional properties and/or to facilitate its processing. Examples of excipients and additives are tracers, contrast agents, carriers, fillers, pigments, dyes, perfumes, lubricants, UV stabilizers, antioxidants or surfactants. In particular, “excipients and additives” are to be understood as any pharmacologically compatible and therapeutically useful substance which is not an active pharmaceutical ingredient, but which can be formulated together with an active pharmaceutical ingredient in a pharmaceutical composition in order to influence, in particular improve, the qualitative properties of the pharmaceutical composition. Preferably, the excipients and/or additives have no or, with regard to the intended treatment, no significant or at least no undesirable pharmacological effect.

Ini is a residue derived from the initiator of the cationic polymerization that leads to the formation of poly(oxazoline). Ini can be an organic residue such as alkyl, cycloalkyl, aryl, aralkyl or heterocyclyl. However, other residues are also possible. Examples of such radicals can be found in U.S. Pat. No. 8,883,211 B2.

Residues R¹², R¹⁵ and Ini can be alkyl. These are generally alkyl groups with one to twenty carbon atoms, which can be straight-chain or branched. Examples are methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl or eicosyl.

Residues R¹¹, R¹³ and R¹⁸ can mean C₆-C₂₀ alkyl. These are alkyl groups with six to twenty carbon atoms, which can be straight-chain or branched. Examples are hexyl, heptyl, octyl, nonyl, decyl, undecyl, dodecyl, tridecyl, tetradecyl, pentadecyl, hexadecyl, heptadecyl, octadecyl, nonadecyl or eicosyl.

R¹ can be C₁-C₄ alkyl. These are alkyl groups with one to four carbon atoms, which can be straight-chain or branched. Examples are methyl, ethyl, propyl and butyl.

Preferably, R¹ is methyl, ethyl or propyl, particularly preferred methyl or ethyl.

Residue Ini can mean cycloalkyl These are usually cycloalkyl groups with five to six ring carbon atoms. Cyclohexyl is particularly preferred.

Residue Ini can mean aryl. These are usually aromatic hydrocarbon radicals with five to ten ring carbon atoms. Phenyl is preferred.

The residue Ini can mean aralkyl. These are usually aryl groups that are connected to the rest of the molecule via an alkylene group. Benzyl is preferred.

Residue Ini can mean heterocyclyl. These are usually aromatic or non-aromatic hydrocarbon radicals with five to ten ring carbon atoms, which have one or two heteroatoms, such as nitrogen and/or oxygen and/or sulphur in the ring.

Residue R¹⁴ can mean alkylene. These are usually alkylene groups with one to six carbon atoms, which can be straight-chain or branched. Examples of alkylene radicals are methylene, ethylene, propylene, butylene, pentylene and hexylene. Preferred are ethylene, propylene and butylene and in particular ethylene.

Residue R¹⁴ can mean cycloalkylene. These are generally cycloalkylene groups with five to six ring carbon atoms. Cyclohexylene is particularly preferred.

Residue R¹⁴ can mean arylene. These are usually divalent aromatic hydrocarbon radicals with five to ten ring carbon atoms. Phenylene is preferred.

Residue R¹⁴ can mean aralkylene. These are usually arylene groups which have an alkylene group, the connection of the aralkylene radical to the remainder of the molecule taking place via the arylene group and the alkylene group. Benzylene is preferred.

R¹⁶ is a divalent to hexavalent (m+1-valent) aliphatic hydrocarbon radical derived from an m+1-valent aliphatic alcohol. One of the OH oxygen atoms of this alcohol is covalently bonded to the polyoxazoline. The remaining OH residues of this alcohol are esterified with fatty acids. If there are several ester groups in the residue, these can be derived from the same or different fatty acids. Examples of divalent alcohols are ethylene glycol or propylene glycol; examples of trivalent alcohols are glycerol or trimethylolpropane; an example of a tetravalent alcohol is pentaerythritol; and examples of hexavalent alcohols are sugar alcohols. Preferably, R¹⁶ is a radical derived from glycerol.

Residue R¹⁷ is a trivalent bicyclic residue. These are usually trivalent radicals that are made up of two cycloalkyl groups, one of these radicals having three ring carbon atoms and the other of these radicals having five to eight ring carbon atoms. The larger of these rings contains a double bond. The bonds with the remainder of the molecule are formed via a covalent bond, which originates from the residue with the three ring carbon atoms, and via two further covalent bonds, which originate from the residue with the five to eight ring carbon atoms.

The first group of polymers according to the invention are linear polymers.

The second group of polymers according to the invention can be linear or branched polymers. Linear polymers are preferred here.

Linear polymers of this second group have structures of the formula (IX) or (X)

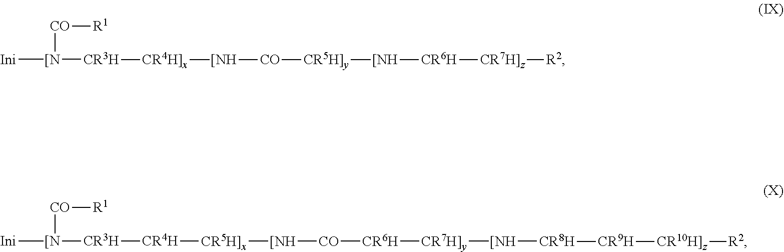

in which R¹, R², R³, R⁴, R⁵, R⁶, R⁷, R⁸, R⁹ and R¹⁰ have the meaning defined above,
x and y independently of one another are integers in the range from 1 to 5000,
z is an integer in the range from 0 to 1000, with the proviso that
the molar proportion of the structural units designated by [ ]ₓ is 10 to 95 mol %, the molar proportion of the structural units designated by [ ]_{y} is 5 to 90 mol %, and the molar proportion of the structural units designated by [ ]_{z} is 0 to 20 mol %, in each case based on the total amount of the structural units designated by [ ]ₓ, [ ]_{y} and [ ]_{z}.

The solubility of the polymers according to the invention can be influenced by co-polymerization with suitable monomers and/or by functionalization. Such techniques are known to the skilled person.

The polymers according to the invention can comprise a wide molar mass range. Typical molecular weights (Mₙ) are in the range from 1,000 to 500,000 g/mol, in particular from 1,000 to 50,000 g/mol. These molar masses can be determined by 1H-NMR spectroscopy of the dissolved polymer. In particular, an analytical ultracentrifuge or chromatographic methods, such as size exclusion chromatography, can be used to determine the molar masses.

Preferred polymers according to the invention have an average molecular weight (number average) in the range from 1,000 to 50,000 g/mol, in particular from 3,000 to 10,000 g/mol, determined by 1H-NMR spectroscopy or by using an analytical ultracentrifuge.

R¹ denotes hydrogen or C₁-C₄ alkyl. Preferably, R¹ denotes hydrogen or C₁-C₃ alkyl, in particular C₁-C₂ alkyl, and most preferably ethyl.

R² denotes OR¹¹, —OCO—R¹¹, —OCO—R¹⁴—CO—OR¹¹, —OCO—R¹⁴—CO—NR¹²R¹³, —NR¹²—R¹⁴—CO—NR¹³R¹⁵, —O—R¹⁶—(O—OC—R¹⁸)ₘ and

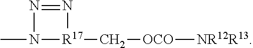

Preferably R² means-OR¹¹, —OCO—R¹¹, —OCO—R¹⁴—CO—OR¹¹ and —OCO—R¹⁴—CO—NR¹²R¹³.

Particularly preferred R² means-OCO—R¹¹, —OCO—R¹⁴—CO—OR¹¹ and —OCO—R¹⁴—CO—NR¹²R¹³.

Most preferred R² means-OCO—R¹⁴—CO—NR¹²R¹³.

R³, R⁴, R⁵, R⁶, R⁷, R⁸, R⁹ and R¹⁰ are independently of one another hydrogen, methyl, ethyl, propyl or butyl.

Preferably, R³, R⁴, R⁵, R⁶, R⁷, R⁸, R⁹ and R¹⁰ are independently of one another hydrogen, methyl or ethyl and in particular only hydrogen.

R¹¹ and R¹⁸ are C₆-C₂₀ alkyl. Preferably, R¹¹ and R¹⁸ are C₈-C₁₈ alkyl and in particular C₁₀-C₁₄ alkyl.

R¹² and R¹⁵ independently of one another are hydrogen or alkyl. Preferably, R¹² and R¹⁵ are C₈-C₁₈ alkyl and in particular C₁₀-C₁₄ alkyl.

R¹³ is C₆-C₂₀ alkyl. Preferably, R¹³ is C₈-C₁₈ alkyl and in particular C₁₀-C₁₄ alkyl.

R¹⁴ means alkylene, cycloalkylene, arylene or aralkylene. Preferably, R¹⁴ is C₁-C₆ alkylene, in particular C₂-C₄ alkylene, in particular C₂ alkylene.

m is an integer from 1 to 5, preferably 2 or 3 and in particular 2.

R¹⁶ is a divalent to hexavalent aliphatic hydrocarbon radical. This is derived from a di- to hexavalent aliphatic alcohol. Preferably, R¹⁶ is a trivalent aliphatic hydrocarbon radical. R¹⁶ is particularly preferred derived from glycerol.

R¹⁷ is a trivalent bicyclic radical. Preferred are radicals of the formula

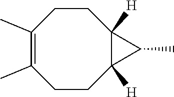

w is an integer in the range from 1 to 5000. w is preferably an integer in the range from 5 to 500 and in particular in the range from 10 to 200.

x and y are independently of one another integers in the range from 1 to 5000. x and y are preferably independently of one another integers in the range from 5 to 500 and in particular in the range from 10 to 200.

z is an integer in the range from 0 to 1000. z is preferably an integer in the range from 0 to 100 and in particular in the range from 0 to 50.

The values for x, y and z are to be selected in the individual case such that the molar proportion of the structural units designated by [ ]ₓ is 10 to 95 mol %, the molar proportion of the structural units designated by [ ]_{y} is 5 to 90 mol %, and the molar proportion of the structural units designated by [ ]_{z} is 0 to 20 mol %. These percentages refer in each case to the total amount of the structural units designated [ ]ₓ, [ ]_{y} and [ ]_{z}.

The molar proportion of the structural units designated [ ]ₓ in the copolymers according to the invention is preferably 20 to 90 mol % and in particular 30 to 70 mol %, based on the total amount of the structural units designated [ ]ₓ, [ ]_{y} and [ ]_{z}.

The molar proportion of the structural units designated [ ]_{y} in the copolymers according to the invention is preferably 10 to 80 mol % and in particular 30 to 70 mol %, based on the total amount of the structural units designated [ ]ₓ, [ ]_{y} and [ ]_{z}.

The molar proportion of the structural units designated by [ ]_{z} in the copolymers according to the invention is preferably 0 to 10 mol % and in particular 0 to 5 mol %, based on the total amount of the structural units designated by [ ]ₓ, [ ]_{y} and [ ]_{z}.

Ini is a radical derived from an initiator of cationic polymerization, preferably an organic radical. It may be alkyl, cycloalkyl, aryl, aralkyl or heterocyclyl. Preferred are alkyl and aryl, particularly preferably C₁-C₆ alkyl, especially methyl.

Preferred are polymers of formulae (I) or (IX), in particular polymers of formula (I).

Preferred are polymers with an Ini radical selected from the group consisting of alkyl, aralkyl or carboxyalkyl.

Also preferred are polymers in which R¹ is C₁-C₃alkyl, in particular methyl or ethyl.

Also preferred are polymers in which R² is selected from the group consisting of —OCO—R¹⁴—CO—OR¹¹, —OCO—R¹⁴—CO—NR¹²R¹³ and

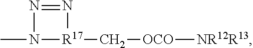

especially preferred R² is a residue of formula-OCO—R¹⁴—CO—NR¹²R¹³.

Furthermore, polymers in which R³, R⁴, R⁵, R⁶, R⁷, R⁸, R⁹ and R¹⁰ are hydrogen are preferred.

Polymers in which R¹¹ or R¹⁸ are C₈-C₁₆ alkyl are also preferred.

Polymers in which R¹² and R¹⁵ are C₆-C₂₀ alkyl, in particular C₈-C₁₆ alkyl, are also preferred.

Polymers in which R¹³ is C₈-C₁₆ alkyl are also preferred.

Polymers in which R¹⁴ is C₂-C₄ alkylene, in particular ethylene, are also preferred.

In further preferred polymers, m is 2 or 3, in particular 2.

Further preferred polymers include polymers in which R¹⁶ is an aliphatic hydrocarbon residue derived from glycerol.

Also preferred are polymers in which R¹⁷ is a radical of the formula

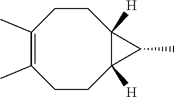

Particularly preferred are polymers in which w is an integer in the range from 5 to 500, x and y independently of one another are integers in the range from 5 to 500, z is an integer in the range from 0 to 100, with the proviso that the molar proportion of the structural units designated by [ ]ₓ is 20 to 90 mol. %, the molar proportion of the structural units designated by [ ]_{y} is 10 to 80 mol. %, and the molar proportion of the structural units designated by [ ]_{z} is 0 to 20 mol %, in each case based on the total amount of the structural units denoted by [ ]ₓ, [ ]_{y} and [ ]_{z}.

Highly preferred are polymers of the formula (I) in which R¹ is ethyl, R² is —OCO—R¹⁴—CO—NR¹²R¹³, R³ and R⁴ are hydrogen, R¹² and R¹³ independently of one another are C₈-C₁₆ alkyl, R¹⁴ is C₂-C₄ alkylene, in particular ethylene, and w is an integer in the range from 5 to 200.

The polymers according to the invention can be produced using conventional polymerization processes. Examples of this are polymerization in substance, polymerization in solution or emulsion or suspension polymerization. These methods are known to the skilled person. Solution polymerization is preferred.

The oxazolines used to produce the poly(oxazoline) s according to the invention are 2-oxazolines (4,5-dihydrooxazoles) with a C═N double bond between the carbon atom 2 and the nitrogen atom. These can be substituted on the 2-, 4- and/or 5-carbon atom and/or on the 3-nitrogen atom, preferably on the 2-carbon atom and/or on the 3-nitrogen atom.

Preferably, 2-oxazolines are used which contain a substituent at the 2-position. Examples of such substituents are methyl or ethyl.

The polymers according to the invention are derived from poly(oxazolines) or poly(oxazines) with selected end groups. These end groups are modified by functionalization. The techniques required for this are known to the person skilled in the art.

Examples of end groups of the poly(oxazoline) or poly(oxazine) starting materials of the polymers according to the invention are halogen atoms, such as fluorine, chlorine, bromine or iodine; or azide groups-N3; or fluoro (alkyl)-sulfonic acid ester groups, such as the nonaflate group —OSO₂C₄F₉, the trifluoromethanesulfonate group —OSO₂CF₃ or the fluorosulfonate group —OSO₂F; or aryl or alkylsulfonic acid groups, such as the tosyl group CH₃—C₆H₄—SO₂— or the mesyl group CH₃—SO₂—; the unsubstituted, mono- or di-substituted amino group NH₂, —NHR or —NR² (where R=monovalent organic radical), the hydroxyl group OH, the thiol group —SH, or the ester group —OCOR, the thioester group SCOR; the phthalimide group or the cyano group —CN as well as other functional groups which can be obtained by modification of these end groups.

The polymers according to the invention can be produced in analogy to known processes in organic chemistry.

The polymers according to the invention can be prepared by different processes.

Common to the processes for preparing the polymers of formulae (I), (II), (IX) or (X) is that the preparation of poly(oxazolines) or of poly/oxazines) is carried out by cationic ring-opening polymerization of oxazolines or oxazines. The polymerization is preferably carried out in solution and in the presence of an initiator. Examples of initiators are electrophiles, such as salts or esters of aromatic sulfonic acids or carboxylic acids or salts or esters of aliphatic sulfonic acids or carboxylic acids or aromatic halogen compounds. Examples of preferred initiators are esters of arylsulfonic acids, such as methyl tosylate, esters of alkanesulfonic acids, such as trifluoromethanesulfonic acid, or mono- or dibromobenzene.

Polar aprotic solvents are usually used as solvents, for example acetonitrile, dimethyl formamide, dimethyl acetamide, ethylene carbonate or dimethyl sulfone.

The reaction temperature is generally between 2° and 180° C., in particular in the range of 70 to 130° C.

The reaction time during polymerization is generally between 5 minutes and 24 hours.

The hydrolysis of poly(oxazolines) or poly(oxazines) is preferably carried out in solution, in particular in an aqueous or alcoholic-aqueous solution. Inorganic or organic acids can be used as acids. Preferably, mineral acids or carboxylic acids are used. Examples include hydrochloric acid, sulphuric acid, nitric acid, acetic acid or formic acid, preferably acetic acid. Suitable bases include alkali hydroxides such as sodium hydroxide or potassium hydroxide.

The reaction temperature during hydrolysis is generally between 2° and 120° C., in particular in the range from 30 to 80° C.

The reaction time during hydrolysis is generally between 5 minutes and 24 hours.

The production of “degPAOx” as starting materials for the production of the second group of polymers according to the invention is described, for example, in WO 2022/106049 A1.

Preferred are processes in which the poly(oxazoline) or poly(oxazine) used is obtained by hydrolysis, in particular by acid hydrolysis.

The end groups of the poly(oxazolines) or poly(oxazines) used as starting materials can be further modified before further processing.

For example, polymers with a carboxylate end group can be converted into polymers with a hydroxyl end group. This can be done by saponification in an aqueous or aqueous-alcoholic solution in the presence of a strong alkali, for example an alkali alcoholate such as sodium methanolate.

The reaction temperature during saponification is generally between 1° and 120° C., in particular in the range from 20 to 60° C.

The reaction time for saponification is generally between 1 and 24 hours.

Polymers with a hydroxyl or amino end group can be further modified by reaction with dicarboxylic acid anhydrides. This produces polymers with carboxyl end groups. For example, polymers with a hydroxyl end group can be converted to polymers with an end group derived from dicarboxylic acids, for example in a reaction of a hydroxyl-terminated polymer with the anhydride of an aliphatic dicarboxylic acid, such as succinic anhydride. The reaction can be carried out in an aprotic solvent, such as dimethyl formamide, in the presence of tertiary amines, such as dimethylaminopyridine and triethylamine.

The reaction temperature in this reaction is generally between 1° and 120° C., in particular in the range from 20 to 60° C.

The reaction time for this reaction is generally between 1 and 24 hours.

Finally, polymers with an end group derived from dicarboxylic acids can be further modified by reaction with a primary or secondary amine. This produces polymers with amide end groups. For example, the carboxyl end group of polymers with an end group derived from dicarboxylic acids can be converted into a corresponding carboxylic acid amide by reaction with a primary or secondary amine. The reaction can be carried out in a polar, aprotic solvent, such as chloroform, in the presence of tertiary amines, such as dimethylaminopyridine. The reaction is also carried out in the presence of known coupling reagents, for example N-hydroxysuccinimide ester (NHS ester), N-hydroxysuccinimide (NHS), dicyclohexylcarbodiimide ester (DCC ester) or 1-ethyl-3-(3-dimethylaminopropyl) carbodiimide ester (EDC ester) or 1-ethyl-3-(3-dimethylaminopropyl) carbodiimide hydrochloride (EDC-HCL).

The reaction temperature for this reaction is generally between 1° and 120° C., in particular in the range from 20 to 60° C.

The reaction time for this reaction is generally between 1 and 24 hours.

In the preparation of the polymers according to the invention, different processes can be used depending on the nature of the residue R². In the preparation of the polymers according to the invention with degPAOx residues, further variations in the preparation processes can also be used.

The polymers of formula (I) or (II), in which R² is —OR¹¹ or —OCO—R¹¹, can be prepared by a process comprising the following steps:
a) providing a polymer of formula (Ia) or (IIa) by cationic polymerization of a 2-oxazoline or a 2-oxazine in the presence of a cationic polymerization initiator

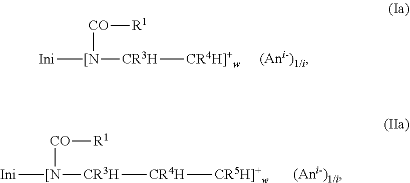

b) termination of the cationic polymerization by addition of a compound of formula (XI) (XII) or (XIIa)

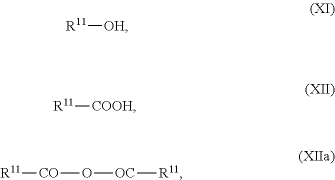

in which, in these formulae, Ini, R¹, R³, R⁴, R⁵, R¹¹ and w have the meaning defined above, i is an integer from 1 to 4 and An is an i-valent anion.

The polymers of formula (I) or (II) in which R² is

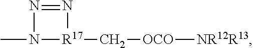

can be prepared by a process comprising the following steps:
a) providing a polymer of formula (Ia)) or (IIa) by cationic polymerization of a 2-oxazoline or a 2-oxazine in the presence of a cationic polymerization initiator

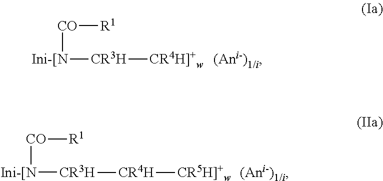

in which Ini, R¹, R³, R⁴, R⁵ and w have the meaning defined above, i is an integer from 1 to 4 and An is an i-valent anion,
c) terminating the cationic polymerization by addition of an inorganic or organic azide, whereby an azide-terminated polymer of the formula (Ib) or (IIb) is formed,

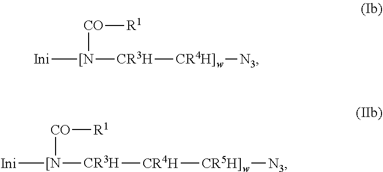

d) reacting the azide-terminated polymer of the formula (Ib) or (IIb) obtained from step c) with a cycloalkyne of the formula (XIII) to give an ester-terminated polymer of the formula (Ic) or (IIc)

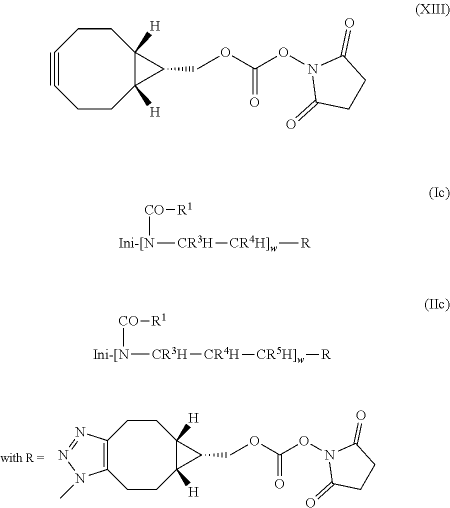

and
e) reacting the ester-terminated polymer of formula (Ic) or (IIc) with an amine of formula (XIV)

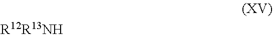

to give a polymer of the formula (I) or (II) in which R² has the meaning defined above, wherein, in these formulae, Ini, R¹, R³, R⁴, R⁵, R¹², R¹³ and w have the meaning defined above, i is an integer from 1 to 4 and An is an i-valent anion.

The polymers of formula (I) or (II) in which R² is —OCO—R¹⁴—CO—OR¹¹ or —OCO—R¹⁴—CO—NR¹²R¹³ can be prepared by a process comprising the following steps:
a) providing a polymer of formula (Ia) or (IIa) by cationic polymerization of a 2-oxazoline or a 2-oxazine in the presence of a cationic polymerization initiator

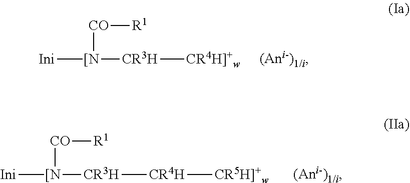

f) terminating the cationic polymerization by adding a compound of formula (XII) or (XIIa) to result in a hydroxyl-terminated polymer of formula (Id) or (IId)

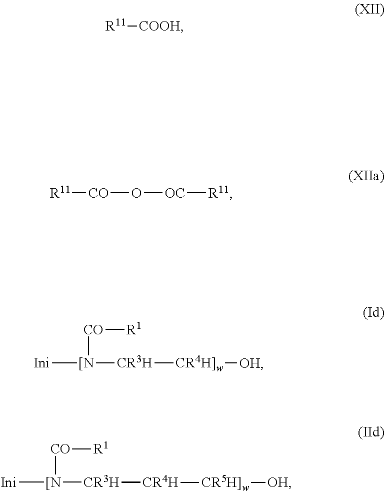

g) reacting the polymers of formula (Id) or (IId) with an anhydride of formula (XVI) to give polymers of formulae (Ie) or (IIe)

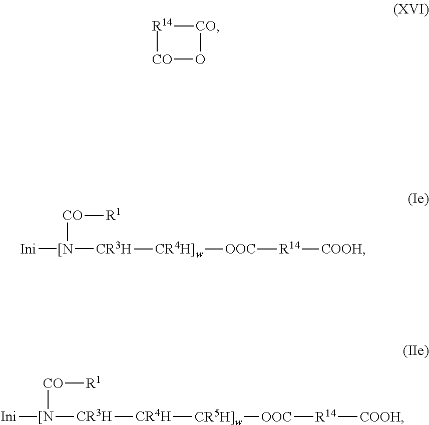

and
h) reacting the polymers of formula (Ie) or (IIe) from step g) with an alcohol of formula (XI) or with an amine of formula (XV) to give polymers of formulae (I) or (II) in which R² has the meaning defined above,

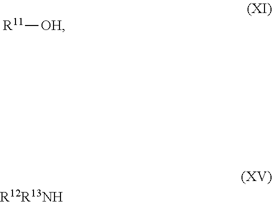

wherein in these formulae Ini, R¹, R³, R⁴, R⁵, R¹¹, R¹², R¹³, R¹⁴ and w are as defined above, i is an integer from 1 to 4 and An is an i-valent anion.

The polymers of formula (I) or (II) wherein R² is —O—R¹⁶—(O—OC—R¹⁸)ₘ can be prepared by a process comprising the following steps:
a) providing a polymer of formula (Ia) or (IIa) by cationic polymerization of a 2-oxazoline or a 2-oxazine in the presence of a cationic polymerization initiator

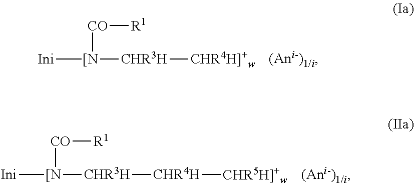

i) terminating of the cationic polymerization by addition of a carboxylic acid, preferably acetic acid, to result in a carboxyl-terminated polymer of the formula (If) or (IIf)

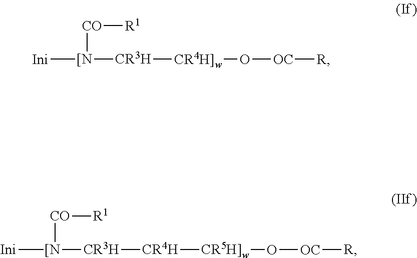

j) reacting the polymers of the formula (If) or (IIf) from step i) with an alkali metal alcoholate, preferably with sodium methanolate, to give polymers of the formulae (Ig) or (IIg)

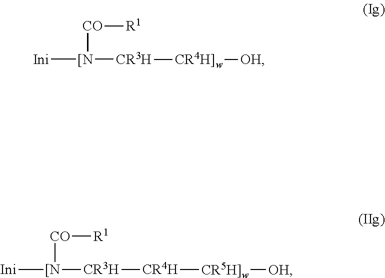

k) reacting the polymers of formula (Ig) or (IIg) from step j) with a dicarboxylic acid anhydride of formula (XVI), preferably with succinic anhydride, to give polymers of formulae (Ih) or (IIh)

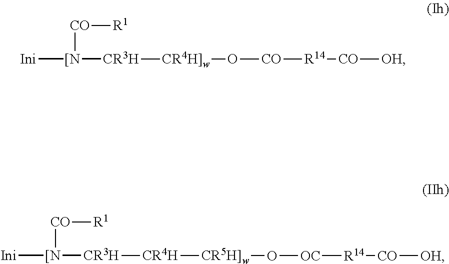

and
I) reacting the polymers of formula (Ih) or (IIh) from step k) with an alcohol of formula (XVII) to give polymers of formulae (I) or (II) in which R² has the meaning defined above,

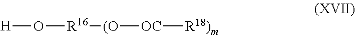

wherein in these formulae Ini, R¹, R³, R⁴, R⁵, R¹⁴, R¹⁶, R¹⁸, m and w are as defined above, i is an integer from 1 to 4 and An is an i-valent anion.

The polymers of formula (I) or (II) wherein R² is —NR¹²—R¹⁴—CO—NR¹³R¹⁵ can be prepared by a process comprising the following steps:
a) providing a polymer of formula (Ia)) or (IIa) by cationic polymerization of a 2-oxazoline or a 2-oxazine in the presence of a cationic polymerization initiator

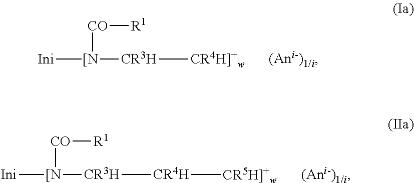

m) terminating the cationic polymerization by addition of an alkali metal phthalimide to give an N-phthalimide-terminated polymer,
n) reacting the polymers from step m) with hydrazine to give polymers of formulae (Ii) or (IIi)

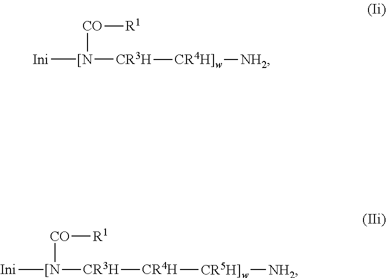

o) reacting the polymers of formula (Ii) or (Ili) from step n) with a dicarboxylic acid anhydride of formula (XVI), preferably with succinic anhydride, to give polymers of formulae (Ij) or (IIj)

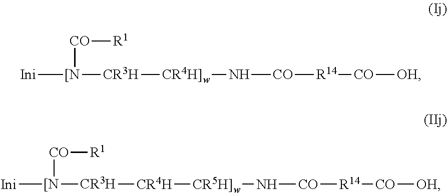

and
p) reacting the polymers of formula (Ij) or (IIj) from step o) with an amine of formula (XV) to give polymers of formulae (I) or (II) in which R² has the meaning defined above

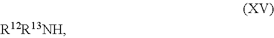

in which, in these formulae, Ini, R¹, R³, R⁴, R⁵, R¹², R¹³, R¹⁴ and w have the meaning defined above, i is an integer from 1 to 4 and An is an i-valent anion.

In the preparation of the copolymers of the second polymer group according to the invention, i.e. copolymers which contain degPAOx radicals, i.e. structural units of formulae (III), (IV) and optionally (V) or of formulae (VI), (VII) and optionally (VIII), different starting materials can be used.

These copolymers can be linear or branched.

The linear types are copolymers of the formulae (IX) or (X). These can be produced in analogy to the linear polymers of the first group, i.e. the polymers of formulae (I) or (II). For this purpose, polyoxazolines or polyoxazines functionalized with residues R² are completely or partially hydrolyzed. The copolymers obtained are then oxidized and, in the case of complete hydrolysis, reacylated, which leads directly to the copolymers of the second polymer group according to the invention. Details of the preparation of copolymers of formulae (IX) and (X) are given below.

The branched types of copolymers containing degPAOx can be partially oxidized by partial oxidation of polyalkyleneimines functionalized with residues R² and the resulting product can be functionalized, for example, by reaction with an activated acyl derivative such as an activated ester or with an acyl halide to give a copolymer of the second polymer group. Details on the preparation of these copolymers are given below. Commercially available polyethyleneimines usually have a branched structure; therefore, the polymers derived therefrom are also branched.

These manufacturing processes for degPAOx copolymers are disclosed in WO 2022/106049 A1.

The linear polymers of formula (IX) or (X) wherein R² is —OR¹¹ or —OCO—R¹¹ can be prepared by a process comprising the following steps:
q) providing a polymer of formula (I)) or (II) wherein R² is —OR¹¹ or —OCO—R¹¹,
r) partial hydrolysis of the polymer of the formula (I) or (II) from step q) to give a copolymer of the formula (Ik) or of the formula (IIk)

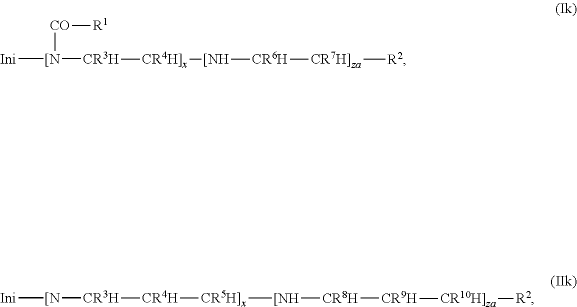

s) reacting the copolymer of the formula (Ik) or (Ilk) from step r) with an oxidizing agent, thereby obtaining a copolymer of the formula (IX) or of the formula (X) in which R² has the meaning defined above,
wherein in these formulae Ini, R¹, R³, R⁴, R⁵, R⁶, R⁷, R⁹, R¹⁰, R¹¹, R¹², R¹³, R¹⁴, R¹⁵, R¹⁶, w, x, y and z have the meaning defined above, and wherein za is an integer with the value w-x.

The linear polymers of formula (IX) or (X) in which R² is

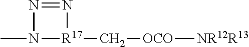

can be prepared by a process comprising the following steps:
t) providing a polymer of formula (I)) or (II) wherein R² is

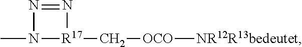

u) partial hydrolysis of the polymer of formula (I) or (II) from step t) to give a copolymer of formula (II) or formula (III)

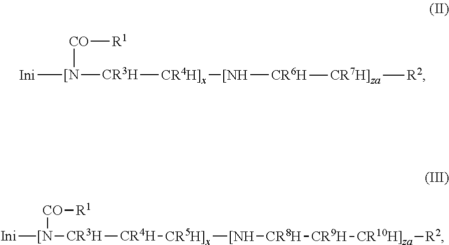

v) reacting the copolymer of formula (II) or (III) from step u) with an oxidizing agent, thereby obtaining a copolymer of formula (IX) or of formula (X) in which R² has the meaning defined above,
wherein in these formulae Ini, R¹, R³, R⁴, R⁵, R⁶, R⁷, R⁹, R¹⁰, R¹², R¹³, w, x, y and z have the meaning defined above, and wherein za is an integer with the value w-x.

The linear polymers of formula (IX) or (X) in which R² is —OCO—R¹⁴—CO—OR¹¹ or —OCO—R¹⁴—CO—NR¹²R¹³ can be prepared by a process comprising the following steps:
w) providing a polymer of formula (I) or (II) wherein R² is —OCO—R¹⁴—CO—OR¹¹ or —OCO—R¹⁴—CO—NR¹²R¹³,
x) partial hydrolysis of the polymer of formula (I) or (II) from step w) to give a copolymer of formula (Im) or formula (IIm)

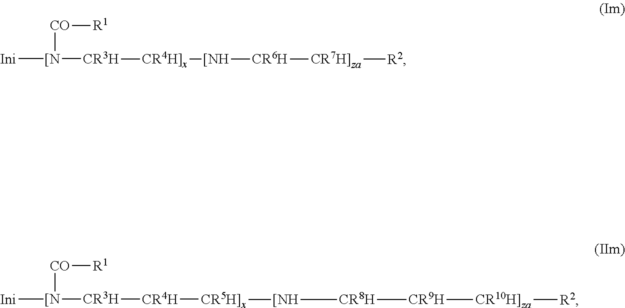

y) reacting the copolymer of the formula (Im) or (IIm) from step x) with an oxidizing agent, thereby obtaining a copolymer of the formula (IX) or of the formula (X) in which R² has the meaning defined above,
wherein in these formulae Ini, R¹, R³, R⁴, R⁵, R⁶, R⁷, R⁹, R¹⁰, R¹¹, R¹², R¹³, R¹⁴, w, x, y and z have the meaning defined above, and wherein za is an integer with the value W—X.

The branched copolymers of the second polymer group, in which R² is —OR¹¹, —OCO—R¹¹, —OCO—R¹⁴—CO—OR¹¹, —OCO—R¹⁴—CO—NR¹²R¹³, —NR¹²—R¹⁴—CO—NR¹³R¹⁵, —O—R¹⁶—(O—OC—R¹⁸)ₘ or

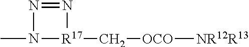

can be prepared by a process comprising the following measures:
z) providing a branched polyethylenimine or polypropylenimine of which at least one end group is functionalized with a radical R²,
aa) partial oxidation of the functionalized polymer from step z), and
bb) introducing —CO—R¹ groups into the polymer from step aa) by reaction with an acyl halide R¹—CO-Hal to form a branched copolymer containing the structural units of formulae (III), (IV) and optionally (V) or containing the structural units of formulae (VI), (VII) and optionally (VIII).
wherein in these formulae R¹, R², R¹¹, R¹², R¹³, R¹⁴, R¹⁵, R¹⁶, R¹⁷, R¹⁸ and m have the meaning defined above.

The oxidation in steps s), v), y) and aa) is preferably carried out in solution, in particular in aqueous or alcoholic-aqueous solution. Oxidants known per se can be used as oxidizing agents. Examples thereof are per-compounds, hypochlorites, chlorine or oxygen, in particular hydrogen peroxide.

Per-compounds are preferably used. Examples of these are hydrogen peroxide, peracids, organic peroxides or organic hydroperoxides, in particular hydrogen peroxide.

Processes in which the oxidizing agent used is hydrogen peroxide are preferred.

The amount of oxidizing agent is selected so that the desired proportion of oxidized structural units is produced in the polymer backbone.

The reaction temperature in this reaction is generally between 1° and 80° C., in particular in the range from 20 to 40° C.

The reaction time for oxidation is generally between 5 minutes and 5 days.

The polymers according to the invention can be used for the production of formulations containing pharmaceutical or agrochemical active ingredients.

Preferably, the polymers according to the invention are used for the production of formulations containing pharmaceutical or agrochemical active ingredients. In particular, these are formulations containing vaccines or nucleic acids, such as ribonucleic acids or desoxynucleic acids.

Due to their good surfactant effect, biocompatibility and the stealth effect, the polymers according to the invention are ideally suited for applications in the field of active ingredient delivery. These uses are also the object of the present invention.

In particular, the polymers of the second group are preferably suitable for the production of formulations containing pharmaceutical or agrochemical active ingredients due to their biodegradability.

The polymers according to the invention can be used as lipids due to their amphiphilic nature. They can be dispersed in hydrophilic liquids, for example as emulsions or suspensions.

Preferably, the polymers according to the invention are present in hydrophilic liquids, such as water or water-alcohol mixtures, in the form of particles, in particular in the form of nanoparticles.

The invention therefore also relates to particles, in particular nanoparticles containing the polymers described above.

Preferred are nanoparticles whose mean diameter D₅₀ is less than 1 μm, preferably 20 to 500 nm.

Particles containing one or more pharmaceutical or agrochemical active ingredients are particularly preferred.

Particularly preferred particles contain, in addition to the polymer according to the invention, at least one active pharmaceutical ingredient as well as suitable excipients and additives.

Preferably, the particles form a disperse phase in a liquid containing water and/or water-miscible compounds.

The proportion of particles in a dispersion can cover a wide range. Typically, the proportion of particles in the dispersion medium is 0.5 to 20% by weight, preferably 1 to 5% by weight.

The particles can be produced by precipitation, preferably by nanoprecipitation. For this purpose, the polymers according to the invention, which are little or not hydrophilic due to the presence of hydrophobic groups, are dissolved in a water-miscible solvent, such as acetone. This solution is dripped into a hydrophilic dispersing medium. This is preferably done with vigorous stirring. This can promote the production of smaller particles. The polymer is deposited in the dispersing medium in finely dispersed form.

Alternatively, the particles can also be produced by emulsification, preferably by nanoemulsion. For this purpose, the polymers according to the invention, which have little or no hydrophilicity due to the presence of hydrophobic groups, are dissolved in a water-immiscible solvent, such as dichloromethane or ethyl acetate. This solution is combined with a hydrophilic dispersing medium, which preferably results in the formation of two liquid phases. This mixture is then emulsified by application of energy, preferably by sonication.

In addition to the polymer according to the invention, one or more active ingredients and/or one or more auxiliaries and additives may be present when the polymer is dispersed in the dispersing medium. Alternatively, these active ingredients and/or auxiliaries and additives can be added after the polymer has been dispersed in the hydrophilic liquid.

Microfluidics for the production of lipid nanoparticles (“LNP”) is particularly suitable here as a formulation method.

For example, LNP can be produced by the ethanol dilution method using a microfluidic device. For this purpose, a lipid solution is prepared in ethanol and an active ingredient, e.g. an RNA, is dissolved in suitable buffer solutions. A cationic lipid or a pH-sensitive cationic lipid for the lipid components is used to encapsulate the active ingredient in LNP. The lipid solutions and the buffered active ingredient solutions are introduced into the microfluidic device, where e.g. positively charged lipids and negatively charged RNAs form complexes via electrostatic interactions. The cationic RNA-lipid complexes are then combined with other lipids to form LNP. Examples of other lipids are cholesterol, phospholipid, PEG lipid or PAOx lipid.

Polymer particles can be separated from hydrophilic liquids in various ways. Examples include centrifugation, ultrafiltration or dialysis.

The polymer dispersion can be further purified after production. Common methods include purification by dialysis, ultrafiltration, filtration or centrifugation.

### Examples

The following examples illustrate the invention without limiting it.

The synthesis of poly(2-ethyl-2-oxazoline) lipids is described below.

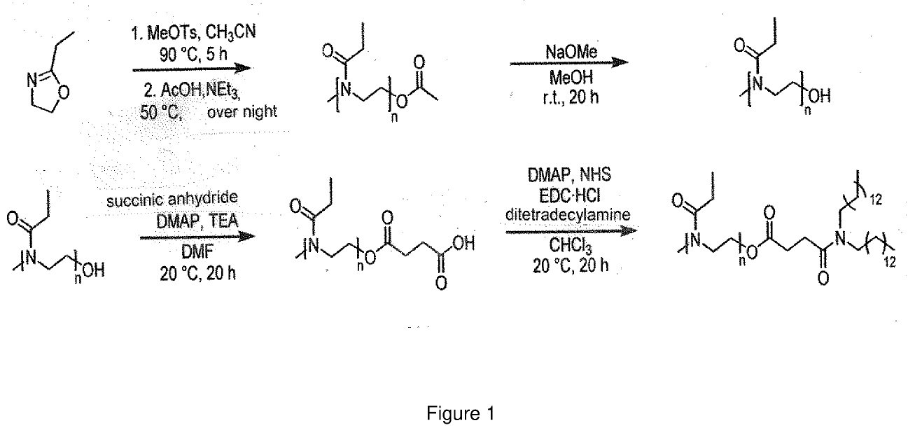

FIG. 1 shows a schematic representation of the synthesis of PEtOx lipids.

The following abbreviations were used in the examples:
MeOH: methanol
EtOH: ethanol
NaOMe: sodium methanolate
DMAP: dimethylaminopyridine
DMF: dimethyl formamide
NHS: N-hydroxy succinimide
EDC-HCl: 1-ethyl-3-(3-dimethylaminopropyl)-carbodiimide hydrochloride

### Materials

All chemicals and solvents were purchased from commercial suppliers and used without further purification unless otherwise stated. 2-Ethyl-2-oxazoline (EtOx, 99+%), triethylamine (NEt₃, 99.7%) and EtOx were purchased from Sigma Aldrich. 2-Ethyl-2-oxazoline was dried over calcium hydride and distilled under argon atmosphere. Methyl tosylate (MeOTs, 98%), Methyl tosylate was dried over barium oxide and distilled under argon atmosphere. Hydrochloric acid (37%) was purchased from Fisher Chemicals. Aqueous hydrogen peroxide solution (30% w/w) was obtained from Carl Roth. Acetyl chloride (approx. 90%) was obtained from Merck Schuchardt. Amberlite IRA-67 was obtained from Merck and was washed several times with deionized water before use. N, N-dimethylformamide (DMF) and acetonitrile were dried in a solvent purification system (MB-SPS-800 from M Braun). Phosphate buffered saline (PBS) was obtained from Biowest. Succinic anhydride (≥99%), N-hydroxysuccinimide (NHS, ≥99%), sodium methanolate (0.5 M in methanol) and BCN—NHS were obtained from Sigma Aldrich. Ditetradecylamine (95%) was purchased from AmBeed. N-(3-Dimethylaminopropyl)-N′-Ethylcarbodiimide Hydrochloride (EDC-HCL) was purchased from Apollo Scientific. Triethylamine (>99%) and 4-dimethylaminopyridine (DMAP, >99%) were acquired from TCI.

### Performance of Measurements

Proton (¹H) nuclear magnetic resonance (NMR) spectra were measured on a Bruker AC 300 MHz or a Bruker AC 400 MHz spectrometer. Correlation spectroscopic (COSY) NMR, heteronuclear single quantum correlation spectroscopic (HSQC) NMR, heteronuclear multiple bond correlation (HMBC) NMR spectra and DOSY NMR spectra were recorded on a Bruker AC 400 MHz spectrometer. Measurements were performed at room temperature using either D₂O, d₄-methanol or deuterated chloroform as solvent. Chemical shifts (δ) are reported in parts per million (ppm) relative to the remaining non-deuterated solvent resonance signal. Infrared (IR) spectroscopy was performed on a Shimadzu IRAffinity-1 CE system equipped with a Quest ATR single reflective diamond crystal ATR cuvette for extended range measurement.

Size exclusion chromatography (SEC) was performed with two different setups. Measurements in N,N-dimethylacetamide (DMAc) were performed using an Agilent 1200 series system equipped with a PSS degasser, a G1310A pump, a G1329A autosampler, a Techlab oven, a G1362A refractive index detector (RID) and a PSS GRAM-guard/30/1000 Å column (10 μm particle size). DMAc with 0.21 wt % LiCl was used as eluent. The flow rate was 1 mL min-1 and the oven temperature was 40° C. Polystyrene (PS) or polymethyl methacrylate (PMMA) standards from 400 to 1,000,000 g mol⁻¹ were used for the calculation of molar masses. Measurements in chloroform were performed using a Shimadzu system (Shimadzu Corp., Kyoto, Japan) equipped with a SCL-10A VP system controller, a SIL-10AD VP autosampler, a LC-10AD VP pump, a RID-10A RI detector, a CTO-10A VP furnace and a PSS SDV guard/lin S-column (5 mm particle size). A mixture of chloroform/isopropanol/-triethylamine (94/2/4 vol %) was used as eluent. The flow rate was 1 mL min⁻¹ and the oven temperature was 40° C. PS standards from 400 to 100,000 g mol⁻¹ were used to calibrate the system.

### Characterization of the Polymers by ¹H-NMR Spectroscopy

The first step in the preparation of PEtOx lipids was the synthesis of PEtOx of different repeating units (20, 40, 50, 60 & 100) via CROP (see synthesis of PEtOx-OAc). CROP was terminated by addition of acetic acid. The degree of polymerization was determined by 1H-NMR spectroscopy via the conversion of monomer to polymer. The hydrolysis was carried out under basic conditions (see synthesis of POx-OH). To obtain complete hydrolysis, the reaction was carried out overnight with NaOMe. The successful synthesis was confirmed by ¹H-NMR, which clearly showed the disappearance of the signals assigned to the CH₃ groups of the OAc-w-end group of PEtOx-OAc. To extend the linker unit, PEtOx-OH was reacted with succinic anhydride (see synthesis of succinylated PEtOx). The product was also characterized by ¹H NMR spectroscopy. To introduce the lipid group, the end group of the succinylated PEtOx was activated by EDC coupling and NHS and reacted with ditetradecylamine. The product was characterized by ¹H-NMR.

### Cationic Ring-Opening Polymerization of Ethyloxazoline (PEtOx OAc)

The synthesis was carried out according to M. Dirauf, A. Erlebach, C. Weber, S. Hoeppener, J. R. Buchheim, M. Sierka, U. S. Schubert, Macromolecules 2020, 53, 3580-3590.

Methyl tosylate (1 eq.) and ethyl oxazoline (20, 40, 50, 60, 100 eq., depending on the desired chain length, were dissolved in anhydrous acetonitrile and heated under reflux. The mixture was cooled, acetic acid (1.5 eq.) and triethylamine (2 eq.) were added sequentially and stirred at 50° C. overnight. The reaction mixture was diluted with CHCl₃ (100 mL), washed with saturated NaHCO₃ solution (3×200 mL) and brine (200 mL). The combined organic phases were dried over Na₂SO₄, the volatile fraction was removed under reduced pressure and dried overnight at 40° C. in vacuo.

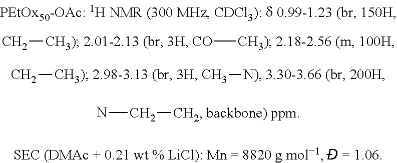

### Synthesis of PEtOx-OH

The synthesis was also carried out according to M. Dirauf, A. Erlebach, C. Weber, S. Hoeppener, J. R. Buchheim, M. Sierka, U. S. Schubert, Macromolecules 2020, 53, 3580-3590.

PEtOx-OAc (1 eq.) was dissolved in anhydrous MeOH (0.15 g mL⁻¹) and NaOMe (0.1 eq., 0.5 M in MeOH) was added with vigorous stirring. The reaction mixture was stirred overnight at room temperature and then the solvent was removed under reduced pressure. The residue was taken up in CHCl₃ and washed with saturated NaHCO₃ (3×200 mL) and brine (200 mL). The combined organic phases were dried over Na₂SO₄ and the solvent was removed under reduced pressure. The product was then dissolved in CH₂Cl₂ and precipitated in ice-cold diethyl ether. The polymer was dried overnight at 40° C. in a vacuum.

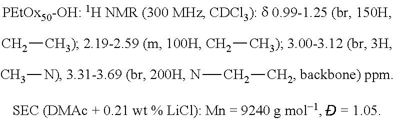

### Synthesis of Succinylated PEtOx

PEtOx-OH (1 eq.) and DMAP (1.05 eq.) were dissolved in anhydrous DMF (c=0.145 M). Triethylamine (0.1 eq.) and succinic anhydride (3 eq.) were added to the mixture and stirred overnight at room temperature. The reaction mixture was then precipitated in ice-cold diethyl ether and then dissolved in dichloromethane. The mixture was then washed with saturated NH₄Cl solution and the combined organic phases were dried over MgSO₄. The volatile components were removed under reduced pressure and redissolved in dichloromethane and precipitated in ice-cold diethyl ether. The resulting solid was dried overnight in a vacuum.

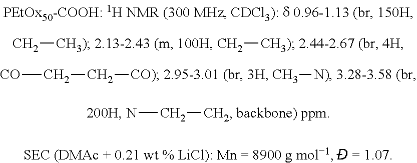

Synthesis of Succinylated PEtOx with Ditetradecylamine

Succinylated PEtOx (1 eq.) was dissolved in anhydrous CHCl₃ and DMAP (0.1 eq.), NHS (2.5 eq.) and EDC-HCl (3 eq.) were added and stirred for 3 h at room temperature. Ditetradecylamine (4 eq.) was added and the mixture was stirred overnight at 45° C. The mixture was then precipitated in ice-cold diethyl ether, redissolved in CH₂Cl₂ and cooled to −20° C. for 3 to 5 h. The precipitate was filtered (0.25 μm PTFE filter), precipitated in ice-cold diethyl ether and dialyzed against EtOH: water (1:1, 1000 Da MWCO dialysis membrane) for 3 days, dialyzed against water for 2 days and then freeze-dried.

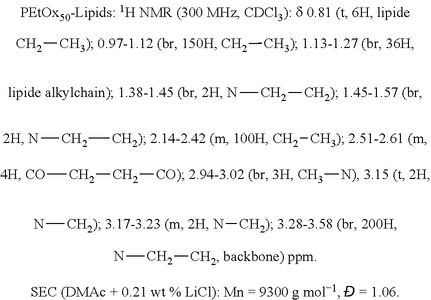

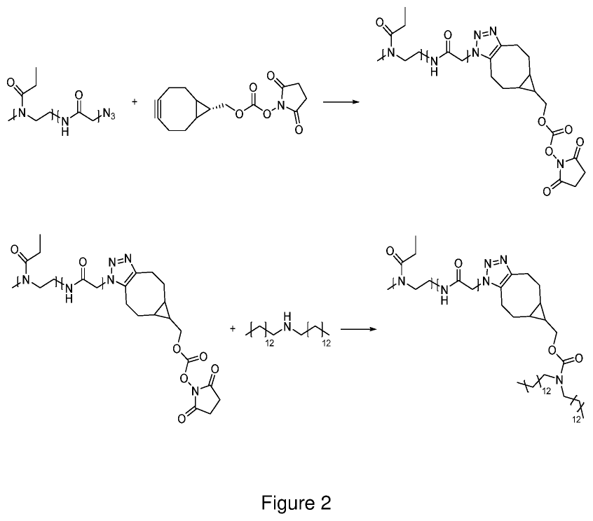

FIG. 2 shows a schematic representation of the synthesis of a degPOx lipid. The linker is activated by strain promoted azide alkyne cycloadditon (SPAAC) and then the lipid is coupled to the linker.

1. Polymers comprising the formulae (I) or (II) 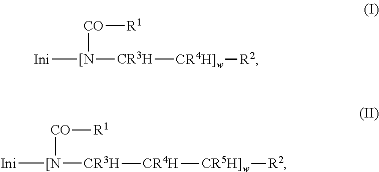
or polymers comprising, based on all structural units, 10 to 95 mol % of structural units of the formula (III), 5 to 90 mol % of structural units of the formula (IV) and 0 to 20 mol % of structural units of the formula (V) 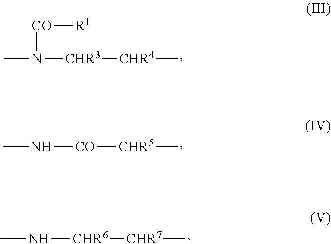
or comprising 10 to 95 mol % of structural units of the formula (VI), 5 to 90 mol % of structural units of the formula (VII) and 0 to 20 mol % of structural units of the formula (VIII) 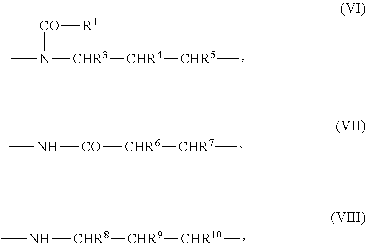
wherein at least one of the structural units of formula (III), (IV) or (V) or of formula (VI), (VII) or (VIII) with the grouping —CHR⁴—, —CHR⁵— or CHR⁷— or with the grouping —CHR⁵—, —CHR⁷— or —CHR¹⁰— is covalently bonded to a radical R²,
wherein
Ini is a radical derived from an initiator of the cationic polymerization,
R¹ is selected from the group consisting of hydrogen or C₁-C₄ alkyl,
R² is selected from the group consisting of —OR¹¹, —OCO—R¹¹, —OCO—R¹⁴—CO—OR¹¹, —OCO—R¹⁴—CO—NR¹²R¹³, —NR¹²—R¹⁴—CO—NR¹³R¹⁵, —O—R¹⁶—(O—OC—R¹⁸)ₘ and 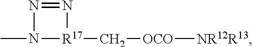
R³, R⁴, R⁵, R⁶, R⁷, R⁸, R⁹ and R¹⁰ independently of one another are hydrogen, methyl, ethyl, propyl or butyl,
R¹¹ is C₆-C₂₀ alkyl,
R¹² and R¹⁵ independently of one another are hydrogen or alkyl,
R¹³ is C₆-C₂₀ alkyl,
R¹⁴ is alkylene, cycloalkylene, arylene or aralkylene,
R¹⁶ is an m+1-valent aliphatic hydrocarbon radical,
R¹⁸ is C₆-C₂₀ alkyl, with the proviso, that several residues R¹⁸ of a residue R¹⁶ may be different within the scope of the given definitions,
m is an integer from 1 to 5,
R¹⁷ is a trivalent bicyclic residue, and
w is an integer in the range from 1 to 5000.

2. Polymers according to claim 1, comprising structures of formula (IX) or (X) 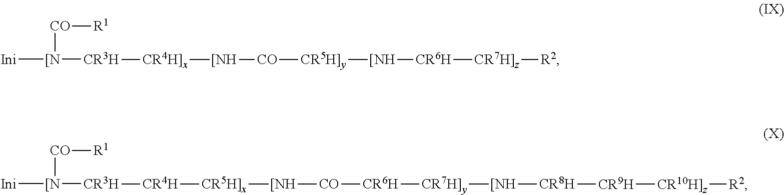
in which R¹, R², R³, R⁴, R⁵, R⁶, R⁷, R⁸, R⁹ and R¹⁰ have the meaning defined in claim 1,
x and y independently of one another are integers in the range from 1 to 5000,
z is an integer in the range from 0 to 1000, with the proviso that the molar proportion of the structural units designated by [ ]ₓ is 10 to 95 mol %, the molar proportion of the structural units designated by [ ]_{y} is 5 to 90 mol %, and the molar proportion of the structural units designated by [ ]_{z} is 0 to 20 mol %, in each case based on the total amount of the structural units designated by [ ]ₓ, [ ]_{y} and [ ]_{z}.

3. Polymers according to claim 1 comprising the formula (I) or (IX).

4. Polymers according to claim 1, comprising the formula (I).

5. Polymers according to claim 1, wherein Ini is selected from form the group consisting of alkyl, aralkyl or carboxyalkyl.

6. Polymers according to claim 1, wherein R¹ is selected from the group C₁-C₃alkyl, methyl and ethyl.

7. Polymers according to claim 1, wherein R² is selected from the group consisting of —OCO—R¹⁴—CO—OR¹¹, —OCO—R¹⁴—CO—NR¹²R¹³ and

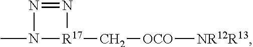

8. Polymers according to claim 1, wherein R³, R⁴, R⁵, R⁶, R⁷, R⁸, R⁹ and R¹⁰ are hydrogen.

9. Polymers according to claim 1, wherein R¹¹ is C₈-C₁₆ alkyl.

10. Polymers according to claim 1, wherein R¹² and R¹⁵ are C₆-C₂₀ alkyl.

11. Polymers according to claim 1, wherein R¹³ is C₈-C₁₆ alkyl.

12. Polymers according to claim 1, wherein R¹⁴ is C₂-C₄ alkylene.

13. Polymers according to claim 1, wherein m is selected from the group of 2 and 3.

14. Polymers according to claim 1, wherein R¹⁶ is an aliphatic hydrocarbon residue derived from glycerine.

15. Polymers according to claim 1, wherein R¹⁷ is a residue of the formula.

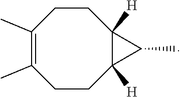

16. Polymers according to claim 1, wherein w is an integer in the range from 5 to 500, x and y independently of one another are integers in the range from 5 to 500, z is an integer in the range from 0 to 100, with the proviso that the molar proportion of the structural units designated by [ ]ₓ is 20 to 90 mol. %, the molar proportion of the structural units designated by [ ]_{y} is 10 to 80 mol. %, and the molar proportion of the structural units designated by [ ]_{z} is 0 to 20 mol %, in each case based on the total amount of the structural units denoted by [ ]ₓ, [ ]_{y} and [ ]_{z}.

17. Polymers according to claim 4, wherein R¹ is ethyl, R² is-OCO—R¹⁴—CO—NR¹²R¹³, R³ and R⁴ are hydrogen, R¹² and R¹³ independently of one another are C₈-C₁₆ alkyl, R¹⁴ is C₂-C₄ alkylene and w is an integer in the range from 5 to 200.

18. A process for manufacturing formulations containing pharmaceutical or agochemical active ingredients comprising the polymers of claim 1.

19. The process according to claim 18, wherein the active ingredient is a vaccine or a nucleic acid.

20. A particle, comprising the polymer according to claim 1.
